(19) United States
(12) Patent Application Publication
(10) Pub. No.: US 2016/0269876 A1
(43) Pub. Date: Sep. 15, 2016

(54) METHOD AND APPARATUS FOR PRESENTING USER PERSONALITIES FOR INTEROPERABLE PTT ACROSS SEPARATE PTT NETWORKS

(71) Applicant: MOTOROLA SOLUTIONS, INC, Schaumburg, IL (US)

(72) Inventors: THOMAS J. SENESE, Schaumburg, IL (US); DANIEL J. MCDONALD, Cary, IL (US); MADHUSUDAN K. PAI, Schaumburg, IL (US); SCOTT J. PAPPAS, Lake Zurich, IL (US); BRIAN R. POE, Cary, IL (US)

(21) Appl. No.: 14/657,541

(22) Filed: Mar. 13, 2015

(51) Int. Cl. H04W 4/10; H04W 76/02; H04W 4/08

(52) U.S. Cl. CPC H04W 4/10; H04W 4/08; H04W 76/021

(57) ABSTRACT

User personalities are presented for interoperable push to talk (PTT) across a plurality of separate PTT networks. A gateway server device (GSD) maintains a user personality mapping that, for each subscriber device and each of a plurality of separate PTT networks communicatively coupled to the GSD, maps a first unique identifier used to identify the subscriber device in a first PTT network with respective second unique identifiers used to identify the subscriber device in other ones of the plurality of PTT networks. The GSD receives a transmission from a source subscriber device in the first PTT network destined for target subscriber devices in the other PTT networks, and modifies the transmission by replacing the first unique identifier with the respective second unique identifiers as a function of the user personality mapping, and forwards the corresponding modified transmissions to the other PTT networks.

### BACKGROUND OF THE INVENTION

A radio access network (RAN) provides for radio communication links to be arranged within the network between a plurality of user terminals. Such user terminals may be mobile and may be known as ‘mobile stations’ or ‘subscriber devices.’ At least one other terminal, e.g. used in conjunction with subscriber devices, may be a fixed terminal, e.g. a BS, eNodeB, repeater, and/or access point. Such a RAN typically includes a system infrastructure that generally includes a network of various fixed terminals, which are in direct radio communication with the subscriber devices. Each of the fixed terminals operating in the RAN may have one or more transceivers which may, for example, serve subscriber devices in a given region or area, known as a ‘cell’ or ‘site’, by radio frequency (RF) communication. The subscriber devices that are in direct communication with a particular fixed terminal are said to be served by the fixed terminal. In one example, all radio communications to and from each subscriber device within the RAN are made via respective serving fixed terminals. Sites of neighboring fixed terminals may be offset from one another and may provide corresponding non-overlapping or partially or fully overlapping RF coverage areas.

RANs may operate according to an industry standard protocol such as, for example, an open mobile alliance (OMA) push to talk (PTT) over cellular (OMA-PoC) standard, a voice over IP (VoIP) standard, or a PTT over IP (PoIP) standard. Typically, protocols such as PoC, VoIP, and PoIP are implemented over broadband RANs including third generation and fourth generation networks such as third generation partnership project (3GPP) Long Term Evolution (LTE) networks.

RANs may additionally or alternatively operate according to an industry standard land mobile radio (LMR) protocol such as, for example, the Project 25 (P25) standard defined by the Association of Public Safety Communications Officials International (APCO), or other radio protocols, the TETRA standard defined by the European Telecommunication Standards Institute (ETSI), the Digital Private Mobile Radio (dPMR) standard also defined by the ETSI, or the Digital Mobile Radio (DMR) standard also defined by the ETSI. Because these systems generally provide lower throughput than the broadband systems, they are sometimes designated narrowband RANs.

Communications in accordance with any one or more of these protocols or standards, or other protocols or standards, may take place over physical channels in accordance with one or more of a TDMA (time division multiple access), FDMA (frequency divisional multiple access), OFDMA (orthogonal frequency division multiplexing access), or CDMA (code division multiple access) protocol. Subscriber devices in RANs such as those set forth above send and receive data (such as encoded voice, audio, image, text, or audio/video streams) in accordance with the designated protocol.

OMA-PoC, in particular, enables familiar PTT and “instant on” features of traditional half duplex subscriber devices, but uses mobile subscriber devices operating over modern broadband telecommunications networks. Using PoC, wireless subscriber devices such as mobile telephones and notebook computers can function as PTT half-duplex subscriber devices for transmitting and receiving. Other types of PTT models and multimedia call models (MMCMs) are also available.

Floor control in an OMA-PoC session is generally maintained by a PTT server that controls communications between two or more wireless subscriber devices. When a user of one of the subscriber devices keys a PTT button, a request for permission to speak in the OMA-PoC session is transmitted from the user's subscriber device to the PTT server using, for example, a real-time transport protocol (RTP) message. If no other users are currently speaking in the PoC session, an acceptance message is transmitted back to the user's subscriber device and the user can then speak into a microphone of the device. Using standard compression/decompression (codec) techniques, the user's voice is digitized and transmitted using discrete auditory data packets (e.g., together which form an auditory data stream over time), such as according to RTP and internet protocols (IP), to the PTT server. The PTT server then transmits the auditory data packets to other users of the PoC session (e.g., to other subscriber devices in the group of subscriber devices or talk group to which the user is subscribed), using for example a unicast, point to multipoint, or broadcast communication technique.

Narrowband LMR systems, on the other hand, operate in either a conventional or trunked configuration. In either configuration, a plurality of subscriber devices is partitioned into separate groups of subscriber devices. In a conventional system, each subscriber device in a group is selected to a particular frequency for communications associated with that subscriber device's group. Thus, each group is served by one channel, and multiple groups may share the same single frequency (in which case, in some embodiments, group IDs may be present in the group data to distinguish between groups using the same shared frequency).

In contrast, a trunked radio system and its subscriber devices use a pool of traffic channels for virtually an unlimited number of groups of subscriber devices (e.g., talk groups). Thus, all groups are served by all channels. The trunked radio system works to take advantage of the probability that not all groups need a traffic channel for communication at the same time. When a member of a group requests a call on a control or rest channel on which all of the subscriber devices at a site idle awaiting new call notifications, in one embodiment, a call controller assigns a separate traffic channel for the requested group call, and all group members move from the assigned control or rest channel to the assigned traffic channel for the group call. In another embodiment, when a member of a group requests a call on a control or rest channel, the call controller may convert the control or rest channel on which the subscriber devices were idling to a traffic channel for the call, and instruct all subscriber devices that are not participating in the new call to move to a newly assigned control or rest channel selected from the pool of available channels. With a given number of channels, a much greater number of groups can be accommodated in a trunked system as compared with conventional radio systems.

A RAN that provides one or more types of PTT services to wireless SDs within its coverage area(s) is referred to as a PTT RAN or PTT network. One type of PTT network may be interconnected with a same type or another type of PTT network via a gateway interface device, such as a Project 25 (P25) Inter-RF Subsystem Interface (ISSI) network interface device, a TErrestrial Trunked RAdio (TETRA) Inter System Interface (ISI) network interface device, and a Open Mobile Alliance (OMA) Network to Network (NNI) network interface device. Group calls from one subscriber device operating in one PTT network type may thus be interconnected with other subscriber devices operating in the same or another type of PTT network via one or more gateway interface devices and one or more local area networks (LANs), wide area networks (WANs), or direct connections.

Group calls may be made between wireless and/or wireline participants in accordance with either or both of a narrowband or a broadband protocol or standard. Group members for group calls may be statically or dynamically defined. That is, in a first example, a user or administrator working on behalf of the user may indicate to the switching and/or radio network (perhaps at a call controller, PTT server, zone controller, or mobile management entity (MME), base station controller (BSC), mobile switching center (MSC), site controller, Push-to-Talk controller, or other network device) a list of participants of a group at the time of the call or in advance of the call. The group members (e.g., subscriber devices) could be provisioned in the network by the user or an agent, and then provided some form of group identity or identifier, for example. Then, at a future time, an originating user in a group may cause some signaling to be transmitted indicating that he or she wishes to establish a communication session (e.g., group call) with each of the pre-designated participants in the defined group. In another example, subscriber devices may dynamically affiliate with a group (and also disassociate with the group) perhaps based on user input, and the switching and/or radio network may track group membership and route new group calls according to the current group membership.

Some subscriber devices may be capable of operating in a plurality of the different PTT networks. For example, a particular subscriber device may roam from one PTT network to another, separate PTT network (of a same or different type), or may power off in one PTT network and subsequently be powered on in another, separate PTT network. In some instances, the same subscriber device may be associated with a different unique identifier in each of the separate PTT networks. A unique identifier and set of user specific attributes such as an alias (also referred to as a “friendly alias”), user name, etc of a subscriber device used in a particular PTT network is called a user personality. For example, the subscriber device may be associated with a unique first identifier called a Session Initiation Protocol (SIP) Uniform Resource Identifier (URI) when operating in a first broadband PTT network (a first user personality), and associated with a different unique second identifier called a SIP URI when operating in a second broadband PTT network (a second user personality). When the subscriber device is operating in the first PTT network and transmitting a group call to other subscriber devices in the first PTT network, the other subscriber devices in the first PTT network receiving the group call may display or otherwise provide the first unique SIP URI to a user so as to identify the transmitting subscriber device and/or user of the transmitting subscriber device. Similarly, when the subscriber device is operating in the second PTT network and transmitting a group call to other subscriber devices in the second PTT network, the other subscriber devices in the second PTT network receiving the group call may display or otherwise provide the second unique SIP URI to a user so as to identify the transmitting subscriber device and/or user of the transmitting subscriber device.

In another example, the subscriber device may be associated with a unique SIP URI when operating in a first broadband PTT network, and associated with a Land Mobile Radio (LMR) Subscriber Unit Identifier (SUID) when operating in a second narrowband PTT network. Other examples and combinations of unique identifiers and types of PTT networks (e.g. MSISDN in a Broadband PTT network) are possible as well.

One problem that has arisen when a same subscriber device is operable in a plurality of separate PTT networks is that a group call initiated by the subscriber device while in a first PTT network may be provided to SDs in a second PTT network with the subscriber device's unique identifier from the first PTT network, which may not be the unique identifier the other subscriber devices and/or dispatch console users in the second PTT network are used to seeing associated with that same subscriber device. In other words, the other subscriber devices in the second PTT network are used to seeing a second unique identifier (e.g., displayed on the other subscriber device's display or otherwise indicated to users of the other subscriber devices) used by the subscriber device when the subscriber device is initiating a group call in the second PTT network, and may not recognize the first unique identifier associated with the subscriber device while in the first PTT network and that is provided to the second PTT network when the subscriber device initiates the group call from the first PTT network. A similar issue may occur for other PTT services, such as an emergency alarm initiated by the subscriber.

Accordingly, what is needed is an improved method and apparatus for presenting user personalities for interoperable group PTT across separate PTT networks.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of a wireless communications network in accordance with some embodiments.

FIG. 2 is a block diagram of a gateway server device in accordance with some embodiments.

FIG. 3 is a block diagram of a subscriber device in accordance with some embodiments.

FIG. 4 includes a flow diagram illustrating a process that may be implemented at the gateway server device of FIG. 2 in accordance with an embodiment.

FIG. 5 includes a flow diagram illustrating a process that may be implemented at the subscriber device of FIG. 3 in accordance with an embodiment.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

Disclosed is an improved method and apparatus for presenting user personalities for interoperable group PTT across separate PTT networks.

In one embodiment, a method for presenting user personalities for interoperable group PTT across a plurality of separate PTT networks comprises: maintaining, at a gateway server device, a user personality mapping that, for each subscriber device and each of a plurality of separate PTT networks communicatively coupled to the gateway server device, maps a first unique identifier used to identify the subscriber device in a first PTT network of the plurality of PTT networks with respective one or more second unique identifiers used to identify the subscriber device in one or more other ones of the plurality of PTT networks; receiving, at the gateway server device from a source subscriber device while the source subscriber device is operating in the first PTT network, a group media transmission destined for target subscriber devices in the one or more other ones of the plurality of PTT networks; and for each of the one or more other ones of the plurality of PTT networks, modifying, by the gateway server device, the group media transmission by replacing the first unique identifier used to identify the source subscriber device in the first PTT network with the respective second unique identifier used to identify the source subscriber device in the other one of the plurality of PTT networks, as a function of the user personality mapping, and forwarding the corresponding modified group media transmission to the other one of the plurality of PTT networks.

In another embodiment, a gateway server device for presenting user personalities for interoperable group PTT across a plurality of separate PTT networks comprises: a memory; a transceiver; and a processor configured to: maintain a user personality mapping that, for each subscriber device and each of a plurality of separate PTT networks communicatively coupled to the gateway server device, maps a first unique identifier used to identify the subscriber device in a first PTT network of the plurality of PTT networks with respective one or more second unique identifiers used to identify the subscriber device in one or more other ones of the plurality of PTT networks; receive, via the transceiver from a source subscriber device while the source subscriber device is operating in the first PTT network, a group media transmission destined for target subscriber devices in the one or more other ones of the plurality of PTT networks; and for each of the one or more other ones of the plurality of PTT networks, modify the group media transmission by replacing the first unique identifier used to identify the source subscriber device in the first PTT network with the respective second unique identifier used to identify the source subscriber device in the other one of the plurality of PTT networks, as a function of the user personality mapping, and forward, via the transceiver, the corresponding modified group media transmission to the other one of the plurality of PTT networks.

In a still further embodiment, a subscriber device for enabling the presentation of user personalities for interoperable group PTT across a plurality of separate PTT networks, the subscriber device comprising: a memory; a transceiver; and a processor configured to: register, via the transceiver, with a first PTT network of the plurality of PTT networks using a first unique identifier used to identify the subscriber device in the first PTT network, and during the registering or subsequent thereto, transmit mapping information that maps the first unique identifier used to identify the subscriber device in the first PTT network with respective second unique identifiers used to identify the subscriber device in one or more other ones of the plurality of PTT networks; and transmit, via the transceiver via the first PTT network, a group media transmission destined for target subscriber devices in the one or more other ones of the plurality of PTT networks, the group media transmission including the first unique identifier of the subscriber device.

Each of the above-mentioned embodiments will be discussed in more detail below, starting with example network and device architectures of the system in which the embodiments may be practiced, followed by a discussion of processes for presenting user personalities for interoperable group PTT across separate PTT networks from a gateway server device perspective and a subscriber device perspective. Further advantages and features consistent with this disclosure will be set forth in the following detailed description, with reference to the figures.

### 1. NETWORK ARCHITECTURE AND DEVICE STRUCTURE

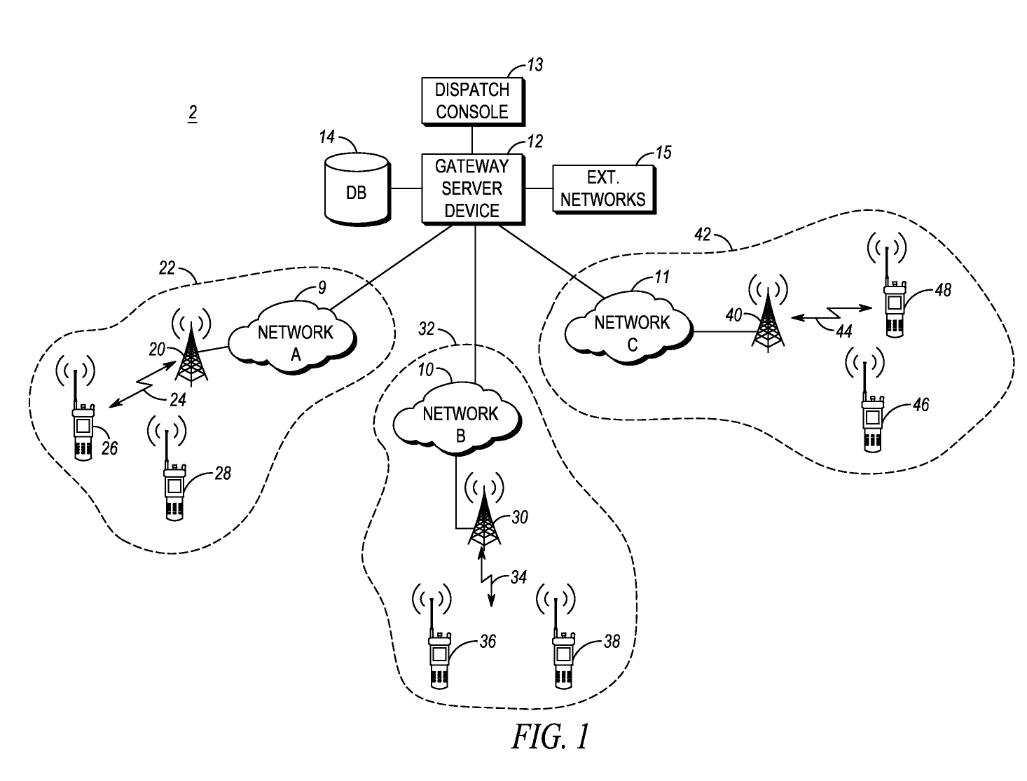

FIG. 1 illustrates a communications network 2 including a gateway server device 12, a dispatch console 13, a database 14, external networks 15, and a plurality of separate PTT networks 22, 32, 42. Within each separate PTT network is one or more respective base stations (BSs) 20, 30, 40 providing corresponding radio coverage cells or sites (not separately illustrated), and a plurality of respective client subscriber devices (SDs) 26, 28, 36, 38, 46, 48. BSs 20, 30, 40 may also be referred to as fixed terminals, eNodeBs, access points, or wireless routers, among other possibilities.

Each BS 20, 30, 40 has at least one radio transceiver providing wireless communications services within its corresponding radio coverage cell or site. One or several of the SDs 26, 28, 36, 38, 46, 48 within radio frequency (RF) coverage of the respective BSs 20, 30, 40 may connect to the BSs 20, 30, 40 using a wireless communication protocol via a respective wireless link 24, 34, 44. The SDs 26, 28, 36, 38, 46, 48 may communicate with each other, and perhaps other devices accessible via other network links, using a group communications protocol over wireless links 24, 34, 44. Wireless links 24, 34, 44 may be, for example, a wireless link supporting a protocol such as GPRS or UMTS, 2G (e.g. GSM), 3G (e.g. WCDMA or LTE), iDEN, wireless LAN (WLAN), ETSI Digital Mobile Radio (DMR), Terrestrial Trunked Radio (TETRA), Association of Public-Safety Communications Officials 25 (APCO P25), or PTT over Cellular (OMA-PoC) or PTT over IP (PoIP), among other possibilities. While each of links 24, 34, 44 is illustrated by a single arrow, each of the links may represent one or more physical or logical radio links, and may represent one or more unicast, multicast, and/or broadcast links between the BS and the SDs in the corresponding site.

Each of the BSs 20, 30, 40 and corresponding wireless links 24, 34, 44 may operate using a same or different protocol. The SDs 26, 28, 36, 38, 46, 48 may be configured with a unique identifier, which may vary based on a type of PTT network, or an identity of a particular PTT network, that the SD is in communication with, and such unique identifiers may include one of a Session Initiation Protocol (SIP) Uniform Resource Identifier (URI), a Land Mobile Radio (LMR) Subscriber Unit Identifier (SUID), a SIP URI alias, an LMR SUID alias, and Mobile Station International Subscriber Directory Number (MSISDN), among other possibilities. SDs equipped to operate in one or more different PTT networks of a same or different type may include a plurality of different unique identifiers, where a particular one of the identifiers is always used when communicating with a particular associated PTT network.

For example, BS 20 in PTT network 22 may operate according to a 3G broadband protocol, BS 30 in PTT network 32 may operate according to a GSM protocol, and BS 40 in PTT network 42 may operate according to an LMR protocol. Each of the BSs 20, 30, and 40 in corresponding PTT networks 22, 32, and 42 may be under control or ownership of a same private or public entity, or different private or public entities. Regardless, PTT networks 22, 32, 42 and gateway server device 12, are configured to allow inter-PTT network group communications to occur across PTT networks 22, 32, and 42.

SD 26, while illustrated in FIG. 1 as currently operating in PTT network 22 and communicatively linked with BS 20, may be configured with a unique SIP URI identifier that uniquely identifies the SD 26 when operating in PTT network 22 and communicatively linked with BS 20, may be further configured with a unique MSISDN identifier that uniquely identifies the SD 26 when operating in PTT network 32 and communicatively linked with BS 30, and may be configured with a unique LMR SUID identifier that uniquely identifies the SD 26 when operating in PTT network 42 and communicatively linked with BS 40. And while, in this example, different protocols are used by BSs 20, 30, and 40 in PTT networks 22, 32, and 42, in other examples, the SD 26 may be equipped with separate unique LMR SUIDs (or other type of identifier) in embodiments in which BSs 20, 30, and 40 in PTT networks 22, 32, and 42 all operate according to a same LMR (or other) protocol. Other examples and/or embodiments are possible as well.

Each SD 26, 28, 36, 38, 46, 48 may be a group communications device, such as a PTT device, that is normally maintained in a monitor only mode, and which switches to a transmit-only mode (half-duplex) or transmit and receive mode (full-duplex) upon depression or activation of a PTT input switch. The group communications architecture in communications network 2 allows a single SD, such as SD 26, to communicate with one or more group members (such as SDs 28, 36, 38, 46, and/or 48) associated with a particular group of SDs at a same time. SDs 26, 28, 36, 38, 46, and/or 48, BSs 20, 30, 40, and/or an infrastructure controller device such as gateway server device 12 may cooperate to define groups of SDs and enable the one-to-many communications feature provided by communications network 2. The term “talk group” may be used throughout this specification to refer to a “group of SD's” and the term “group call” may be used throughout this specification to refer to a one-to-many communication between the member SDs in the group of SDs. The terms are not intended to be limited to voice communications, but rather, to embody all possible group communications payloads, including but not limited to, voice, data, text, video, audio, audio/video, images, and/or any other type of media stream. Furthermore, although the examples below generally illustrate an example group call across two or more separate and distinct PTT networks, same or similar steps and functions may be applied to individual (private) calls across two separate and distinct networks, communicating individual or private media transmissions between a source PTT device and a target device. Still further, although the examples below generally illustrate an example media transmission across separate and distinct PTT networks, same or similar steps and functions may be applied to a signaling transmission across separate and distinct networks, including but not limited to an emergency alarm signal being transmitted from a source PTT device to a target device.

Although only six SDs and three BSs are illustrated in FIG. 1, the present disclosure is not limited as such, and more or fewer SDs and more or fewer BSs could be used in any particular implementation. Furthermore, while database 14 is illustrated as directly coupled to gateway server device 12, database 14 may also be remote from gateway server device 12 and accessible to gateway server device 12 via one or more of PTT networks 22, 32, 42 and/or external networks 15.

Each BS 20, 30, 40 is linked to the gateway server device 12 via a respective network A 9, B 10, or C 11. Each respective network A 9, B 10, or C 11 may comprise one or more routers, wirelines, wireless links, switches, LANs, evolved packet cores (EPCs), WLANs, WANs, access points, base station controllers (BSCs), mobile switching centers (MSCs), site controllers, zone controllers, Push-to-Talk controllers, or other PTT network infrastructure device(s). For example, gateway server device 12 may be accessible to BSs 20, 30, 40 via a dedicated wireline, an EPC, or via the Internet. In still further embodiments, gateway server device 12 may be disposed within one of networks A 9, B 10, or C 11, or within one or more of BSs 20, 30, and 40, and accessible via inter-connected networks same or similar to that illustrated by networks A 9, B 10, and C 11. As just one example, the gateway server device 12 functionality described herein may be disposed in a PTT call controller device resident in each of the networks A 9, B 10, and C 11.

Gateway server device 12 may be a separate device configured to maintain a database of SD personality mappings across separate PTT networks. For each SD in the personality mapping (in this case, SDs 26, 28, 36, 38, 46, and/or 48), and for each of a plurality of separate PTT networks communicatively coupled to the gateway server device 12 (in this case, PTT networks 22, 32, and 42), maps a first unique identifier used to identify the SD in a first PTT network (e.g., PTT network 22) of the plurality of PTT networks with respective one or more second unique identifiers used to identify the SD in one or more other ones of the plurality of PTT networks (e.g., PTT networks 32 and 42).

The gateway server device 12 may further provide mechanisms and/or interfaces for receiving, from a source SD such as SD 26 while the SD 26 is operating in a first PTT network 22, a group media transmission destined for target SDs such as SDs 36, 38, 46, 48 in one or more other PTT networks 32, 42, and for each of the one or more other PTT networks, modifying the group media transmission by replacing a first unique identifier used to identify the source SD 26 in the first PTT network 22 with respective second unique identifiers used to identify the source/transmitting SD in the other PTT networks 32, 42, as a function of the personality mapping maintained by the gateway server device 12. The gateway server device 12 may then forward the corresponding modified group media transmission(s) to the other PTT networks 32, 42 for further distribution to target SDs 36, 38, 46, 48 within those PTT networks. In another example, the gateway server device 12 may further provide mechanisms and/or interfaces for receiving, from a source SD such as SD 26 while the SD 26 is operating in a first PTT network 22, a private or individual media transmission destined for a target SD such as SD 36 in PTT network 32, and for modifying the private media transmission by replacing a first unique identifier used to identify the source SD 26 in the first PTT network 22 with a second unique identifier used to identify the source/transmitting SD in the PTT network 32, as a function of the personality mapping maintained by the gateway server device 12. The gateway server device 12 may then forward the modified private media transmission to the other PTT network 32 for further distribution to target SD 36. In still another example, the target in the destination PTT network may be a dispatch console or some other infrastructure device in place of a target subscriber device. Same or similar modifications are made for group or private media transmissions targeted to such infrastructure target devices.

Database 14 may function to store the SD personality mappings maintained by the gateway server device 12. The database 14 may be pre-populated with personality mappings, or may be updated with new personality mappings by gateway server device 12 as SDs register with a PTT network 22, 32, 42 and provide mapping information to gateway server device 12 via their registering PTT network. Database 14 may also store group membership information that, for each group of SDs, stores unique identifier information (perhaps including information identifying which PTT network each group member is currently attached to) for each SD. When a new group media transmission addressed to a particular group of SDs (i.e., including a group identifier identifying the target group) is received at gateway server device 12, the gateway server device 12 may retrieve the group membership information for the target group and correspondingly route modified versions of the group media transmission to the group members at their respective PTT network (e.g., modified in accordance with the present disclosure for presenting user personalities for interoperable group PTT).

External networks 34 may also be accessible to BSs 20, 30, 40 (and thus SDs 26, 28, 36, 38, 46, 48) via gateway server device 12. External networks 34 may include, for example, a public switched telephone network (PSTN), the Internet, or another wireless service provider's network, among other possibilities.

A dispatch console 13 may be directly coupled to gateway server device 12 as shown, or may be indirectly coupled to gateway server device 12 via one or more intervening networks, including but not limited to external networks 34 or networks A 9, B 10, or C 11. The dispatch console 13 allows an administrator or dispatcher to initiate infrastructure-sourced group communications to groups of SDs 26, 28, 36, 38, 46, 48, among other features and functions.

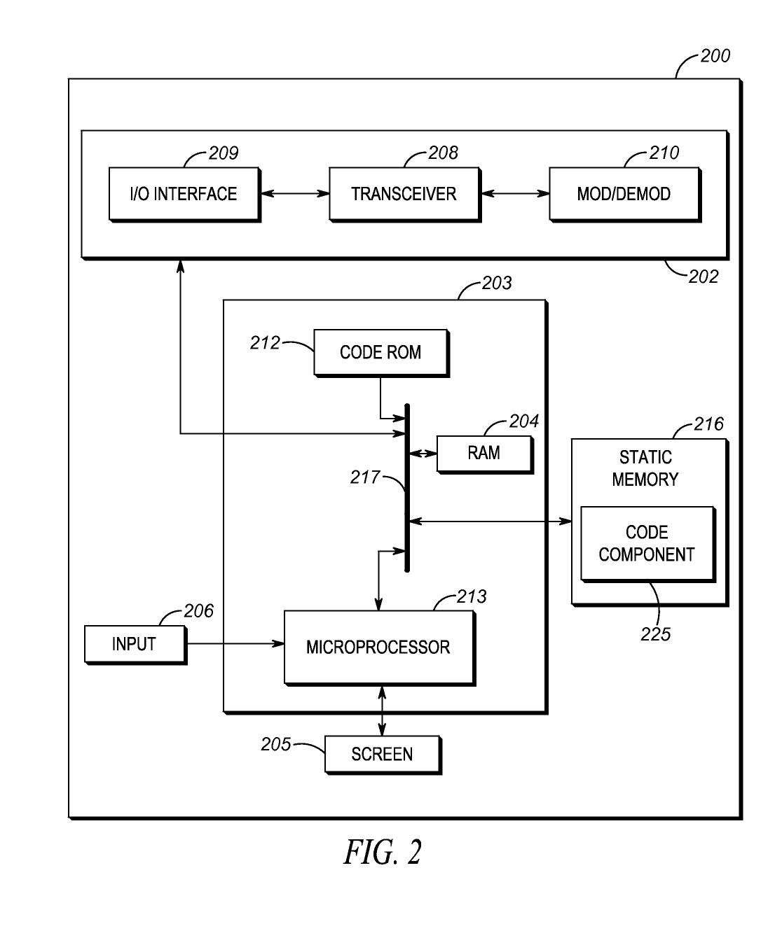

Referring to FIG. 2, a schematic diagram illustrates a gateway server device 200 according to some embodiments of the present disclosure. Gateway server device 200 may be, for example, the same as or similar to the gateway server device 12 of FIG. 1. As shown in FIG. 2, gateway server device 200 includes a communications unit 202 coupled to a common data and address bus 217 of a processing unit 203. The gateway server device 200 may also include an input unit (e.g., keypad, pointing device, etc.) 206 and a display screen 205, each coupled to be in communication with the processing unit 203.

The processing unit 203 may include a code Read Only Memory (ROM) 212 coupled to the common data and address bus 217 for storing data for initializing system components. The processing unit 203 may further include a microprocessor 213 coupled, by the common data and address bus 217, to a Random Access Memory (RAM) 204 and a static memory 216.

The communications unit 202 may include one or more wired or wireless input/output (I/O) interfaces 209 that are configurable to communicate with PTT networks 22, 32, 42, external networks 15, dispatch console 13, and/or database 14. The communications unit 202 may include one or more wireless transceivers 208, such as a DMR transceiver, a P25 transceiver, a Bluetooth transceiver, a Wi-Fi transceiver perhaps operating in accordance with an IEEE 802.11 standard (e.g., 802.11a, 802.11b, 802.11g), a WiMAX transceiver perhaps operating in accordance with an IEEE 802.16 standard, and/or other similar type of wireless transceiver configurable to communicate via a wireless radio network. The communications unit 202 may additionally or alternatively include one or more wireline transceivers 208, such as an Ethernet transceiver, a Universal Serial Bus (USB) transceiver, or similar transceiver configurable to communicate via a twisted pair wire, a coaxial cable, a fiber-optic link or a similar physical connection to a wireline network. The transceiver 208 is also coupled to a combined modulator/demodulator 210.

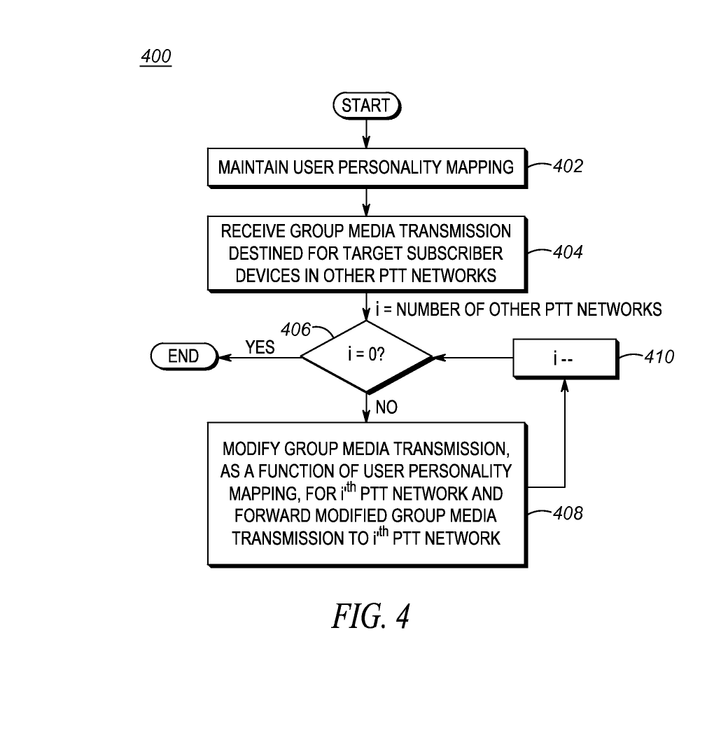

The microprocessor 213 has ports for coupling to the input unit 206 and to the display screen 205. Static memory 216 may store operating code for the microprocessor 213 that, when executed, performs one or more of the gateway server device processing, transmitting, and/or receiving steps set forth in FIG. 4 and accompanying text. Static memory 216 may also store, permanently or temporarily, information disclosed above as being stored at database 14, including but not limited to SD personality mappings and SD group membership information

Static memory 216 may comprise, for example, a hard-disk drive (HDD), an optical disk drive such as a compact disk (CD) drive or digital versatile disk (DVD) drive, a solid state drive (SSD), a tape drive, a flash memory drive, or a tape drive, to name a few.

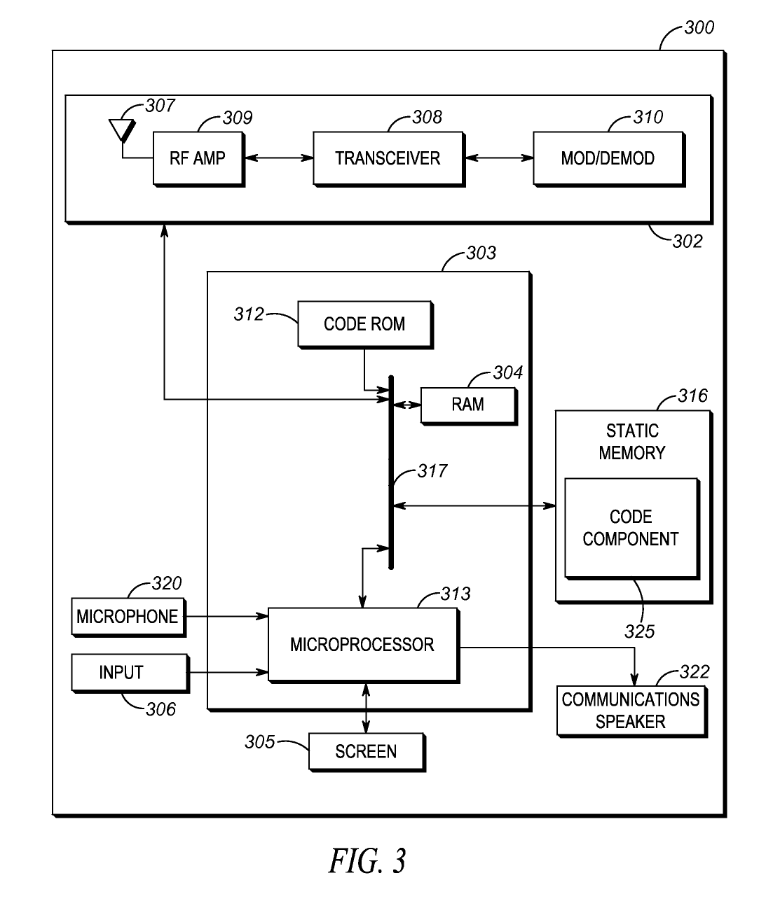

Referring to FIG. 3, a schematic diagram illustrates an SD 300 according to some embodiments of the present disclosure. SD 300 may be, for example, the same as or similar to the SD 26 of FIG. 1. Other SDs such as SDs 28, 36, 38, 46, 48 may contain same or similar structures. As shown in FIG. 3, SD 300 comprises a radio frequency communications unit 302 coupled to a common data and address bus 317 of a processing unit 303. The SD 300 may also include an input 306 and a display screen 305, each coupled to be in communication with processing unit 303. A microphone 320 captures audio from a user that is further vocoded by processing unit 303 and transmitted as voice data by communication unit 302 to other SDs or other devices in the PTT network. A communications speaker 322 reproduces audio that is decoded from voice data transmissions received from other SDs or from the PTT network via the communications unit 302. Display screen 305 may reproduce image or video data decoded from communication media received from other SDs via the communications unit 302.

The processing unit 303 may also include a code ROM 312 for storing data for initializing system components. The processing unit 303 may further include a microprocessor 313 coupled, by the common data and address bus 317, to a RAM 304 and a static memory 316.

The radio frequency communications unit 302 is a combined receiver (or receivers) and transmitter (or transmitters), e.g., transceiver(s) 308, having a common antenna 307. In some embodiments, additional separate or shared antennas may be provided for each one or more transmitter and/or receiver. The radio frequency communications unit 302 has the transceiver 308 coupled to the antenna 307 via a radio frequency amplifier 309. The transceiver(s) 308 may be a transceiver operating in accordance with one or more standard protocols, such as a DMR transceiver, a P25 transceiver, a TETRA transceiver, a Bluetooth transceiver, an LTE transceiver, a Wi-Fi transceiver perhaps operating in accordance with an IEEE 802.11 standard (e.g., 802.11a, 802.11b, 802.11g), a WiMAX transceiver perhaps operating in accordance with an IEEE 802.16 standard, and/or other similar type of wireless transceiver configurable to communicate via a wireless network. The transceiver 308 is also coupled to a combined modulator/demodulator 310. In some embodiments, multiple transceivers capable of operating with multiple different PTT networks including a first LMR transceiver capable of operating within LMR PTT networks such as a DMR or P25 transceiver, and a second Broadband transceiver capable of operating within Broadband PTT networks such as an LTE transceiver, may be present in the radio frequency communications unit 302. In other embodiments, a single programmable transceiver capable of communicating in accordance with two or more of the above-noted protocols may be present. Furthermore, other combinations of two or more transceivers 308 capable of operating on a plurality of different PTT networks may be present in the radio frequency communications unit 302.

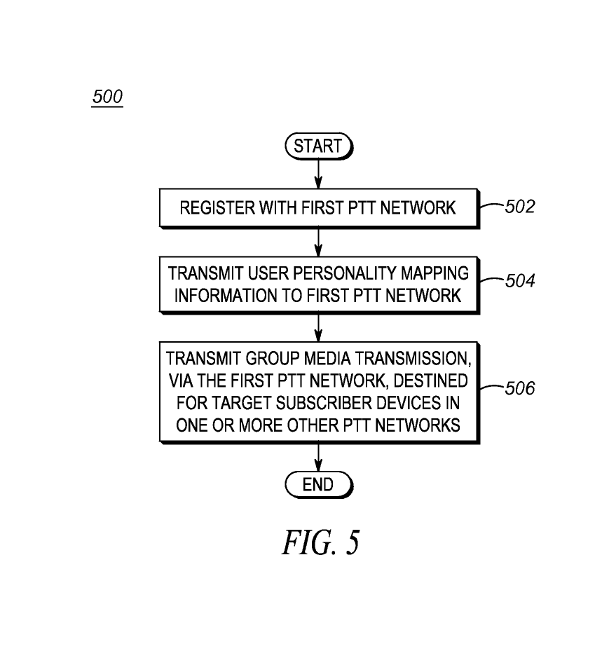

The microprocessor 313 has ports for coupling to the input 306 and to the display screen 305. The microprocessor 313 further has ports for coupling to the microphone 320 and to the speaker 322, and/or other input and output devices. In some embodiments of the present disclosure, the static memory 316 may store operating code for the microprocessor 313 that, when executed by the microprocessor 313, perform one or more of the SD processing, transmitting, and/or receiving steps set forth in FIG. 5 and accompanying text. Static memory 316 may comprise, for example, a HDD, an optical disk drives such as a CD drive or DVD drive, a SSD, a tape drive, a flash memory drive, or a tape drive, to name a few.

### 2. PROCESSES FOR PRESENTING USER PERSONALITIES FOR INTEROPERABLE GROUP PTT

FIGS. 4-5 set forth flow charts illustrating processes 400, 500 for presenting user personalities for interoperable group PTT from the perspectives of a gateway server device (400) and an SD (500). The process 400 of FIG. 4 may be implemented at a gateway server device such as the gateway server device 200 of FIG. 2 and/or the gateway server device 12 of FIG. 1. The process 500 of FIG. 5 may be implemented at an SD such as the SD 300 of FIG. 3 and/or the SD 26 of FIG. 1. Of course, additional steps not disclosed herein could be additionally added before, after, or in-between steps disclosed in FIGS. 4-5, and the presence of such additional steps would not negate the purpose and advantages of the examples set forth in detail throughout the remainder of this disclosure.

a. Gateway Service Device Processes for Presenting User Personalities for Interoperable Group PTT

Gateway server device process 400 of FIG. 4 starts at step 402, in which a gateway server device maintains a user personality mapping. As set forth earlier, the gateway server device may maintain a database of SD personality mappings across separate PTT networks, and may store and access such a database locally at the gateway server device or via a remote connection with an external database, among other possibilities. For each SD in the personality mapping, and for each of a plurality of separate PTT networks communicatively coupled to the gateway server device, the user personality mapping maps a first unique identifier used to identify the SD in a first PTT network of the plurality of PTT networks with respective one or more second unique identifiers used to identify the SD in one or more other ones of the plurality of PTT networks. Each SD's mapping may be pre-configured at the gateway server device or external database via a provisioning process, or may be dynamically added to the database when such mapping information is explicitly provided by an SD upon registration with one of the plurality of PTT networks.

For example, an SD personality mapping entry may be set forth in a database similar to the entry set forth in Table I below.

TABLE I
Example SD Personality Mapping Entry

| SUID for | SIP URI for | SUID/Alias for | SIP URI/Alias for |
|---|---|---|---|
| System1 | System2 | System3 | System4 |
| wacnlds- | George1@PoC- | waczwdd- | George2@PoC- |
| george1 | domain | george2/GeorgeCast | domain/George |

As illustrated in Table I, an SD personality mapping entry in a database stored at or accessible to the gateway server device sets forth, for each of four separate PTT networks, including two broadband networks identifying the SD using a SIP URI and two LMR networks identifying the SD using an SUID, a unique identifier used by the SD when the SD is operating in that PTT network (e.g., within the coverage area of, and receiving wireless communications services from, a mobile or fixed access point or BS of that PTT network). In other words, and for example, when the SD is registering with LMR PTT network System1 to receive wireless communications service therefrom, it identifies itself using its SUID of “wacnlds-george1” during registration, and when the SD is transmitting group media to other SDs also operating within the System1 PTT network, the identity of the source/transmitting SD is displayed at each of the other SDs in the target group of the group media transmission as “wacnlds-george1”. Similarly, when the SD is registering with Broadband PTT network System2 to receive wireless communications service therefrom, it identifies itself using its SIP URI of “George1@PoC-domain” during registration, and when the SD is transmitting group media to other SDs also operating within the System2 PTT network, the identity of the source/transmitting SD is displayed at each of the other SDs in the target group of the group media transmission as “George1@PoC-domain”.

Columns 3 and 4 of Table I set forth variations of the SUID and SIP URI entries in columns 1 and 2 that further include a named Alias for the respective SUID and SIP URI also included in the mapping. Aliases may be used to provide a ‘friendly name’ to an identifier so that SDs can be more easily and quickly recognized by a receiving SD user. Accordingly, the SD personality mapping may include, in addition to the unique identifier used to identify the SD with respective PTT networks, an alias for that unique ID that may be used by the gateway server device in subsequent steps when modifying group media transmissions. For example, in this case, when the SD is registering with LMR PTT network System3 to receive wireless communications service therefrom, it identifies itself using its SUID of “waczwdd-george2” during registration. However, because the SUID of “waczwdd-george2” may not provide a quick and easy identification of a user when presented to target SDs, the SD may also register an alias of “waczwdd-george2” with PTT network System3 of “GeorgeCast”. When the SD is transmitting group media to other SDs also operating within the System3 PTT network, the SD's SUID of “waczwdd-george2” may still be used to identify the SD internally and to route transmissions through the PTT network, but the alias may be used at destination SDs and/or dispatch consoles in the target networks to display the identity of the source SD as “GeorgeCast” when the group media transmission is received at the target destination SDs. Similar considerations are afforded the broadband SIP URI/Alias set forth in column 4.

The mappings set forth in Table I above may have been pre-provisioned at the gateway server device or some storage database accessible thereto, or may have been provided to the gateway service device via one of the PTT networks System1-4 when the SD registered with the respective PTT network and provided some or all of the mapping information set forth in Table I. Additional portions of the mappings may have been provided when the SD registered with a second one of the PTT networks System1-4. Other possibilities exist as well. While Table I illustrates four separate PTT networks, including two broadband networks identifying the SD using a SIP URI and two LMR networks identifying the SD using an SUID, other numbers of PTT networks and combinations of types of PTT networks could be used as well.

Returning to process 400 of FIG. 4, at step 404, the gateway server device receives, from the SD, a group media transmission destined for target SDs in other PTT networks. For example, the transmission may be to a group entitled “StatePolice,” which includes group members located across a plurality of separate PTT networks. The gateway server device, upon receipt of the group media transmission, may access a group membership database and retrieve unique SD identities of the group members, including perhaps identities of PTT networks with which the SD group members are currently/actively associated. This way, a group media transmission from one SD in one PTT network may be distributed to other SDs in the target group even if they are currently receiving wireless service in a separate PTT network. In another embodiment, the group media transmission may itself identify a plurality of individual SDs to receive the group media transmission, in a header or embedded data portion thereof, perhaps by using their unique SD identifiers such as SUIDs or SIP URIs, among other possibilities. In the latter case, the gateway server device may access a registration database to determine PTT networks with which the target SDs identified in the group media transmission itself are currently registered.

Once the gateway server device has identified the destination active/registered SDs for the group media transmission and the PTT networks they are currently active/registered with, it sets a variable ‘i’ equal to the number of separate PTT networks that the group media transmission must be forwarded to in order to reach all currently active members of the target group. For example, SDs in a group may be spread across two, five, fifteen, or one hundred separate PTT networks, and the transmitting source SD may wish for the group media transmission to be distributed to each group member across those two, five, fifteen, or one hundred separate PTT networks. In this example, it is assumed that the group media transmission is transmitted to a group that has SDs present at each of the three separate PTT networks Systems 2-4 (e.g., excluding the source PTT network System1) in Table I above. Accordingly, i is set to three and acts as an index to refer to each of the three separate PTT networks Systems 2-4 of Table I.

At step 406, the gateway server device determines if ‘i’ is equal to zero. If i is equal to zero, there are no more separate PTT networks to forward the group media transmission to, and processing ends. On the other hand, if i is not equal to zero, processing proceeds to step 408. In this case, i is three and processing proceeds to step 408.

At step 408, the gateway server device modifies the group media transmission received at step 404, as a function of an entry in the user personality mapping for the source/transmitting SD associated with the i'th PTT network (System4 in this case), and forwards the modified group media transmission to the i'th PTT network. For example, the group media transmission received from the SD of Table 1 above while the SD was operating in System1 is modified by the gateway server device by replacing the unique identifier associated with the SD in the source/transmitting PTT network (wacnlds-george1) with the SIP URI/Alias associated with the SD in the target PTT network System4 (George2@PoC-domain/George). The gateway server device then forwards the modified group media transmission to the System4 PTT network for further distribution to group member SDs in the System4 PTT network. For example, the source SD's unique identifier “wacnlds-george1” may be disposed in a header portion of the group media transmission, and the gateway server device replaces the “wacnlds-george1” identifier from System1 with the SD's corresponding identifier from System4 “George2@PoC-domain/George”, prior to forwarding the modified group media transmission to System4. In another example, the source SD's unique identifier “wacnlds-george1” may be disposed in an embedded data portion of the group media transmission, and the gateway server device replaces the “wacnlds-george1” identifier from System1 with the SD's corresponding identifier from System4 “George2@PoC-domain/George”, prior to forwarding the modified group media transmission to System4. In this case, the target PTT network System4 and/or the receiving SDs in System4 can make the determination of whether to use the SIP URI, the Alias, or both in identifying the source/transmitting SD from System1.

After modifying the group media transmission, as a function of the user personality mapping for the source/transmitting SD and the i'th target PTT network, processing proceeds to step 410, where the variable i is decremented (in this case, to two) before returning to step 406.

At step 406, the gateway server device again determines if ‘i’ is equal to zero. If i is equal to zero, there are no more separate PTT networks to forward the group media transmission to, and processing ends. On the other hand, if i is not equal to zero, processing proceeds to step 408. In this case, i is two and processing proceeds back to step 408.

At step 408, the gateway server device again modifies the group media transmission received at step 404, as a function of an entry in the user personality mapping for the source/transmitting SD associated with the i'th PTT network (System3 in this case), and forwards the modified group media transmission to the i'th PTT network. For example, the group media transmission received from the SD of Table 1 above while the SD was operating in System1 is modified by the gateway server device by replacing the unique identifier associated with the SD in the source/transmitting PTT network (wacnlds-george1) with the SUID/Alias associated with the SD in the target PTT network System 3 (waczwdd-george2/GeorgeCast). The gateway server device then forwards the modified group media transmission to the System3 PTT network for further distribution to group member SDs in the System3 PTT network. The group media transmission may be modified in a same or similar fashion as set forth above with respect to System4. In this case, the target PTT network System3 and/or the receiving SDs in System3 can make the determination of whether to use the SUID, the Alias, or both in identifying the source/transmitting SD from System1.

After modifying the group media transmission, as a function of the user personality mapping for the source/transmitting SD and the i'th target PTT network, processing proceeds to step 410, where the variable i is decremented (in this case, to one) before returning to step 406.

At step 406, the gateway server device again determines if ‘i’ is equal to zero. If i is equal to zero, there are no more separate PTT networks to forward the group media transmission to, and processing ends. On the other hand, if i is not equal to zero, processing proceeds to step 408. In this case, i is one and processing proceeds back to step 408.

At step 408, the gateway server device again modifies the group media transmission received at step 404, as a function of an entry in the user personality mapping for the source/transmitting SD associated with the i'th PTT network (System2 in this case), and forwards the modified group media transmission to the i'th PTT network. For example, the group media transmission received from the SD of Table 1 above while the SD was operating in System1 is modified by the gateway server device by replacing the unique identifier associated with the SD in the source/transmitting PTT network (wacnlds-george1) with the SIP URI associated with the SD in the target PTT network System 2 (George1@PoC-domain). The gateway server device then forwards the modified group media transmission to the System2 PTT network for further distribution to other group member SDs in the System2 PTT network. The group media transmission may be modified in a same or similar fashion as set forth above with respect to System4.

After modifying the group media transmission, as a function of the user personality mapping for the source/transmitting SD and the i'th target PTT network, processing proceeds to step 410, where the variable i is decremented (in this case, to zero) before returning to step 406.

At step 406, the gateway server device again determines if ‘i’ is equal to zero. If i is equal to zero, there are no more separate PTT networks to forward the group media transmission to, and processing ends. On the other hand, if i is not equal to zero, processing proceeds to step 408. In this case, i is zero and processing for process 400 ends.

While in the example process of FIG. 4, the group media transmission was sequentially modified prior to forwarding the modified group media transmission(s) to target PTT networks, in other embodiments, such steps may be executed in parallel, or some combination thereof.

b. SD Processes for Presenting User Personalities for Interoperable Group PTT

In order to support gateway server device process 400, SD process 500 of FIG. 5 may be executed at SDs such as the SD 300 of FIG. 3 and/or the SD 26 of FIG. 1. SD process 500 starts at step 502, in which an SD registers with a first PTT network using a first unique identifier to uniquely identify the SD in the first PTT network. The first PTT network may be any of the PTT network types discussed above and the unique identifier may be of any of the identifier types discussed above. During or after registering, and at step 504, the SD transmits a user personality mapping information to the first PTT network that maps the first unique identifier used to identify the SD in the first PTT network with respective second unique identifiers used to identify the SD in one or more other ones of a plurality of PTT networks that are or may be communicatively coupled to the first PTT network. For example, the user personality mapping information may take the form as set forth in Table I above, with or without the unique identifier information for the first PTT network (i.e., column I) included in the mapping information. The SD may additionally present other elements of the personality such as a user's alias corresponding to each respective second unique identifier.

Subsequently, at step 506, the SD transmits a group media transmission, via the first PTT network, destined for target SDs in the one or more other separate PTT networks. The group media transmission may, for example, identify a group identifier as a target of the group media transmission, which can be used by the gateway server device to identify target active SDs that are members of or otherwise associated with the group identifier, or the group media transmission may identify a plurality of individual SDs itself, perhaps by using their unique identifiers such as SUIDs or SIP URIs, among other possibilities. The group media transmission includes the first unique identifier of the SD used to uniquely identify the SD in the first PTT network, perhaps in a header portion of the group media transmission or in an embedded data portion of the group media transmission.

### 3. CONCLUSION

In accordance with the foregoing, an improved method and apparatus for presenting user personalities for interoperable group PTT across separate PTT networks. As a result, a more flexible, robust, and adaptable multi-PTT network communication system can be provided, improving safety across many geographic regions and functions. Other advantages and benefits are possible as well.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method for presenting user personalities for interoperable push to talk (PTT) across a plurality of separate PTT networks, the method comprising:
maintaining, at a gateway server device, a user personality mapping that, for each subscriber device out of a plurality of subscriber devices and for each of a plurality of separate PTT networks communicatively coupled to the gateway server device, maps a first unique source identifier used to identify the subscriber device in a first PTT network of the plurality of PTT networks with respective one or more second unique source identifiers used to identify the subscriber device in one or more other ones of the plurality of PTT networks;
receiving, at the gateway server device from a source subscriber device out of the plurality of subscriber devices while the source subscriber device is operating in the first PTT network, a transmission destined for one or more target devices in the one or more other ones of the plurality of PTT networks, the transmission including a particular first unique source identifier identifying the source subscriber device as a source of the transmission; and
for each of the one or more other ones of the plurality of PTT networks, modifying, by the gateway server device, the transmission by replacing the particular first unique source identifier used to identify the source subscriber device as the source of the transmission in the first PTT network with a respective particular second unique source identifier used to identify the source subscriber device as the source of the transmission in the other one of the plurality of PTT networks, as a function of the user personality mapping, and forwarding the corresponding modified transmission to the other one of the plurality of PTT networks.

2. The method of claim 1, wherein the transmission is a group media transmission destined for a plurality of target devices in the one or more other ones of the plurality of PTT networks, wherein the plurality of target devices are subscriber devices.

3. The method of claim 1, wherein the user personality mapping further, for each subscriber device and for each of the plurality of separate PTT networks communicatively coupled to the gateway server device, maps a friendly alias associated with the first unique source identifier used to identify the source subscriber device in the first PTT network of the plurality of PTT networks with respective one or more second friendly aliases associated with the second unique source identifiers used to identify the source subscriber device in the one or more other ones of the plurality of PTT networks.

4. The method of claim 1, wherein the transmission is a media transmission, and wherein the particular first unique source identifier used to identify the source subscriber device in the first PTT network is in a header portion of the media transmission, and is replaced with the respective particular second unique source identifier used to identify the source subscriber device in the other one of the plurality of PTT networks.

5. The method of claim 1, wherein the transmission is a media transmission, and wherein the first unique source identifier used to identify the source subscriber device in the first PTT network is embedded in data portions of the media transmission, and is replaced with the respective second unique source identifier used to identify the source subscriber device in the other one of the plurality of PTT networks.

6. The method of claim 1, wherein the first and second unique source identifiers comprise one of a Session Initiation Protocol (SIP) Uniform Resource Identifier (URI), a Land Mobile Radio (LMR) Subscriber Unit Identifier (SUID), a SIP URI alias, an LMR SUID alias, and Mobile Station International Subscriber Directory Number (MSISDN).

7. The method of claim 1, wherein maintaining the user personality mapping comprises storing a pre-provisioned mapping in a database accessible to the gateway server device.

8. The method of claim 1, wherein maintaining the user personality mapping comprises receiving, at the gateway server device from the source subscriber device upon registration of the source subscriber device with the first PTT network or subsequent to such registration, mapping information that maps the particular first unique source identifier used to identify the source subscriber device in the first PTT network of the plurality of PTT networks with the respective particular second unique source identifiers used to identify the source subscriber device in one or more other ones of the plurality of PTT networks, and storing the mapping information in the user personality mapping.

9. The method of claim 1, wherein the gateway server device is one of a Project 25 (P25) Inter-RF Subsystem Interface (ISSI) network interface device, a TErrestrial Trunked RAdio (TETRA) Inter System Interface (ISI) network interface device, and an Open Mobile Alliance (OMA) Network to Network (NNI) network interface device.

10. The method of claim 1, wherein the gateway server device is communicatively coupled to three or more separate PTT networks, and the user personality mapping maps the first unique source identifier used to identify the source subscriber device in the first PTT network of the plurality of PTT networks with two or more respective second unique source identifiers used to identify the source subscriber device in two or more other ones of the plurality of PTT networks, and wherein the two or more respective second unique source identifiers are different from one another and different from the first unique source identifier.

11. The method of claim 1, wherein for each of the one or more other ones of the plurality of PTT networks, the respective second particular unique source identifier used to identify the source subscriber device as the source of the transmission is the unique source identifier used by the source subscriber device to identify the source subscriber device as the source of a further transmission by the source subscriber device while the source subscriber device is in the other one of the plurality of PTT networks.

12. A gateway server device for presenting user personalities for interoperable push to talk (PTT) across a plurality of separate PTT networks, the device comprising:
a memory;
a transceiver; and
a processor configured to:
maintain a user personality mapping that, for each subscriber device out of a plurality of subscriber devices and for each of a plurality of separate PTT networks communicatively coupled to the gateway server device, maps a first unique source identifier used to identify the subscriber device in a first PTT network of the plurality of PTT networks with respective one or more second unique source identifiers used to identify the subscriber device in one or more other ones of the plurality of PTT networks;
receive, via the transceiver from a source subscriber device out of the plurality of subscriber devices while the source subscriber device is operating in the first PTT network, a transmission destined for target devices in the one or more other ones of the plurality of PTT networks, the transmission including a particular first unique source identifier identifying the source subscriber device as a source of the transmission; and
for each of the one or more other ones of the plurality of PTT networks, modify the transmission by replacing the particular first unique source identifier used to identify the source subscriber device as the source of the transmission in the first PTT network with a respective particular second unique source identifier used to identify the source subscriber device as the source of the transmission in the other one of the plurality of PTT networks, as a function of the user personality mapping, and forward, via the transceiver, the corresponding modified transmission to the other one of the plurality of PTT networks.

13. The gateway server device of claim 12, wherein the transmission is a group media transmission destined for a plurality of target devices in the one or more other ones of the plurality of PTT networks, wherein the plurality of target devices are subscriber devices.

14. The gateway server device of claim 12, wherein the transmission is a media transmission, and wherein the particular first unique source identifier used to identify the source subscriber device in the first PTT network is in a header portion of the media transmission, and is replaced with the respective particular second unique source identifier used to identify the source subscriber device in the other one of the plurality of PTT networks.

15. The gateway server device of claim 12, wherein the transmission is a media transmission, and wherein the first unique source identifier used to identify the source subscriber device in the first PTT network is embedded in data portions of the media transmission, and is replaced with the respective second unique source identifier used to identify the source subscriber device in the other one of the plurality of PTT networks.

16. The gateway server device of claim 12, wherein the processor is further configured to maintain the user personality mapping by storing a pre-provisioned mapping in a database accessible to the gateway server device.

17. The gateway server device of claim 12, wherein the processor is further configured to maintain the user personality mapping by receiving, via the transceiver from the source subscriber device upon registration of the source subscriber device with the first PTT network or subsequent to such registration, mapping information that maps the particular first unique source identifier used to identify the source subscriber device in the first PTT network of the plurality of PTT networks with the respective particular second unique source identifiers used to identify the source subscriber device in one or more other ones of the plurality of PTT networks, and storing the mapping information in a storage device communicatively coupled to the gateway server device.

18. The gateway server device of claim 12, wherein the gateway server device is communicatively coupled, via the transceiver, to three or more separate PTT networks, and the user personality mapping maps the first unique source identifier used to identify the source subscriber device in the first PTT network of the plurality of PTT networks with two or more respective second unique source identifiers used to identify the source subscriber device in two or more other ones of the plurality of PTT networks, and wherein the two or more respective second unique source identifiers are different from one another and different from the first unique source identifier.

19. The gateway server device of claim 12, wherein for each of the one or more other ones of the plurality of PTT networks, the respective second particular unique source identifier used to identify the source subscriber device as the source of the transmission is the unique source identifier used by the source subscriber device to identify the source subscriber device as the source of a further transmission by the source subscriber device while the source subscriber device is in the other one of the plurality of PTT networks.

20. A subscriber device for enabling the presentation of user personalities for interoperable push to talk (PTT) across a plurality of separate PTT networks, the subscriber device comprising:
a memory;
a transceiver; and
a processor configured to:
register, via the transceiver, with a first PTT network of the plurality of PTT networks using a first unique source identifier used to identify the subscriber device in the first PTT network, and during the registering or subsequent thereto, transmit mapping information that maps the first unique source identifier used to identify the subscriber device in the first PTT network with respective second unique source identifiers used to identify the subscriber device in one or more other ones of the plurality of PTT networks; and
transmit, via the transceiver via the first PTT network, a transmission destined for target devices in the one or more other ones of the plurality of PTT networks, the transmission including the first unique source identifier of the subscriber device.
